(19) United States
(12) Patent Application Publication
(10) Pub. No.: US 2024/0264677 A1
(43) Pub. Date: Aug. 8, 2024

(54) System and Method of Touchless Hand Gesture Based Text Input into Computing Devices without the Need for a Hand-Wearable Device

(71) Applicant: David Homyk, New York, NY (US)

(72) Inventor: David Homyk, New York, NY (US)

(21) Appl. No.: 18/096,554

(22) Filed: Jan. 12, 2023

Related U.S. Application Data
(60) Provisional application No. 63/397,893, filed on Aug. 14, 2022.

(51) Int. Cl. G06F 3/01

(52) U.S. Cl. CPC G06F 3/017

(57) ABSTRACT

The technology disclosed allows a user to input text into a computing device with their hands using a graphically displayed, 3D displayed (including but not limited to those being stereoscopic, multiscopic, holographic or immersive media), or projected keyboard without physically touching the device nor any physical hardware component and without having to wear a separate device on their hand or hands in order to do so. The technology functions by using the computing device's built-in webcam, external webcam or other image capturing hardware, including but not limited to radar or radar assisted detection, infrared or infrared assisted detection, or any combination of these technologies, to track the positions and gestures of the user's hands for the purpose of interpreting interactions with the displayed or projected keyboard. The user is therefore free to be at a distance from the computing device while nonetheless inputting text into said device for purposes including but not limited to typing and word processing, sending electronic correspondence such as but not limited to email or other messaging, transmitting data over the internet, entering a query into or interacting with a software application, controlling a game console or Smart TV, also known as a connected TV (CTV), searching or navigating a local or remote file system or file directory, retrieving a file, launching or opening a file in a designated application, or composing artwork.

### BACKGROUND

The need for interaction with a computing device without having to physically touch such device nor any of its hardware components has gone up considerably in recent years due to the COVID-19 pandemic. During the pandemic The Centers for Disease Control and Prevention issued mandates to thoroughly clean the surfaces of shared areas designated as “high-touch” after each use. Such surfaces are increasingly none other than shared computing devices. Examples where computing devices require use by more than one individual include but are not limited to those where personal information is entered into a form during an intake process at an office or clinic, where personal information is input for the purpose of designating a position in line or for creating a reservation at an establishment such as a restaurant, nightclub or place of public gathering, or where a user is expected to place their own food or beverage order at a digital kiosk.

In situations where medical professionals have soiled hands or soiled gloves during the performance of a surgery, procedure, examination or any such process there is usually the accompanying and intermittent need for interaction with one or more computing devices. As it currently stands such processes must be stopped and a cleanup protocol followed ahead of such interaction with said computing devices, only after which the professionals in question are permitted to once again prepare for, according to another clean up and initiation protocol, and eventually resume the original process.

In an operating room where a surgeon must adjust an instrument, record telemetry or correspond with another physician during the course of a surgery, being able to input adjustments, input and save data or type and send electronic messages without stopping the surgery each time to go through cleanup protocols followed by initiation protocols would greatly serve the efforts of speed and efficiency in these situations, which are most often highly time-sensitive. It would also reduce the environmental impact from the ongoing disposal of single-use gloves and numerous other single-use products required for surgery.

In another example consider a dentist who must search for and retrieve a patient's chart during the performance of a routine cleaning with said patient. In the middle of the cleaning the need arises to see earlier X-rays of the patient's mandible in order to evaluate and confirm suspected gum deterioration, bone loss or some other supposed change. The dentist would have to interrupt the cleaning session, remove their gloves, go through a cleanup process often in another room leaving the patient in unattended abeyance, then input the patient's name into the computing device to retrieve their chart and earlier X-rays, only to go through the process of cleaning up once more and preparing to resume the routine cleaning so that they could compare the current state of the patient's mandible with the patient's earlier X-rays. The ability to input the patient's name into the computing device without touching the computing device would obviate the need for the aforementioned circuitousness.

As the popularity of Smart TVs, also known as connected TVs (CTVs), continues to grow, the need for text input into said devices is concomitant. The old technology of the original remote control featuring power, volume, channels, playback, track change and other common features, was hastily extended for Smart TVs to include a standalone keyboard to facilitate typing. This expedient effort has bloated remote controls with a ponderousness beyond their original intent, creating an awkward and cumbersome challenge for Smart TV users. The ability to input text into a Smart TV without the need for the obsolete and unwieldy remote control is self-evident as it not only drastically improves the user experience but obviates the familiar concerns of losing remote controls or getting them confused with the remote controls of other devices.

From commercial to home kitchens there is a never ending need to be able to type without touching a screen. In a commercial kitchen chefs and line cooks must communicate with waitstaff via computing devices which track patrons' orders. To do so they must cease their tasks, wash their hands, type a response to an incoming order to communicate the current state of the kitchen, for instance that a key ingredient has just run out, hence, a menu item is no longer available, or that the queue is particularly long for a new order due to the state of prior orders currently in preparation, then reengage their tasks only to be interrupted moments later by the anticipated response from waitstaff, therefore having to cleanup and reply all over again. At a small to average size restaurant this happens dozens if not hundreds of times during peak dinner hours. Not only are output and sales commensurate with the speed of a restaurant's kitchen but customer satisfaction as well. Patrons will walk out on a restaurant that is unable to bring out orders in a timely fashion. Having a touchless method of interacting with the computing device to communicate with waitstaff, thereby avoiding the interruption of countless cleanups, would result in generating more income, retaining more customers and even avoiding costly fines from the health department should a kitchen worker attempt to violate sanitary code by skipping as little as one cleanup.

At home anyone working in their kitchen knows the difficulty of trying to prepare food while following a recipe. Old soiled cookbooks tell the story that before our now ubiquitous phones, tablets, laptops and desktop computers we would rush back and forth referencing our procedures with wet hands covered in various ingredients. Today we have the luxury of searching anywhere online for recipes, comparing and combining recipes, experimenting with different techniques and watching demonstrative videos, all within the single session of preparing a dish. The problem that arises is that our computing devices are less forgiving of damage than our cookbooks were decades ago. Being able to perform the aforementioned tasks without having to touch our computing devices would cut down the risk of damage inflicted from smearing, caking and flinging ingredients of various viscosities onto them.

### BRIEF SUMMARY OF THE INVENTION

The technology disclosed allows a user to input text into a computing device with their hands using a graphically displayed, 3D displayed (including but not limited to those being stereoscopic, multiscopic, holographic or immersive media), or projected keyboard without physically touching the device nor any physical hardware component and without having to wear a separate device on their hand or hands in order to do so. The technology functions by using the computing device's built-in webcam (web camera), external webcam (auxiliary web camera) or other image capturing hardware, including but not limited to radar or radar assisted detection, infrared or infrared assisted detection, or any combination of these technologies, to track the positions and gestures of the user's hands for the purpose of interpreting interactions with the displayed or projected keyboard.

The user is therefore free to be at a distance from the computing device while nonetheless inputting text into said device for purposes including but not limited to typing and word processing, sending electronic correspondence such as but not limited to email or other messaging, transmitting data over the internet, entering a query into or interacting with a software application, controlling a game console or Smart TV, also known as a connected TV (CTV), searching or navigating a local or remote file system or file directory, retrieving a file, launching or opening a file in a designated application, or composing artwork.

### BRIEF DESCRIPTION OF THE DRAWINGS

FIG. 1 illustrates a user 006 holding up both hands 007 and 008 so as to reveal their relative positions and gestures to a webcam 002 on a computing device 001. Recognition of the user's hand positions is indicated by the circles 004 and 005 overlaid on the graphically displayed keyboard 003 which, for this example, is a QWERTY keyboard. The user's thumbs relative to the other fingers are separated so as to convey unpinched gestures to the webcam 002, which are further indicated by the overlaid circles 004 and 005 being solid.

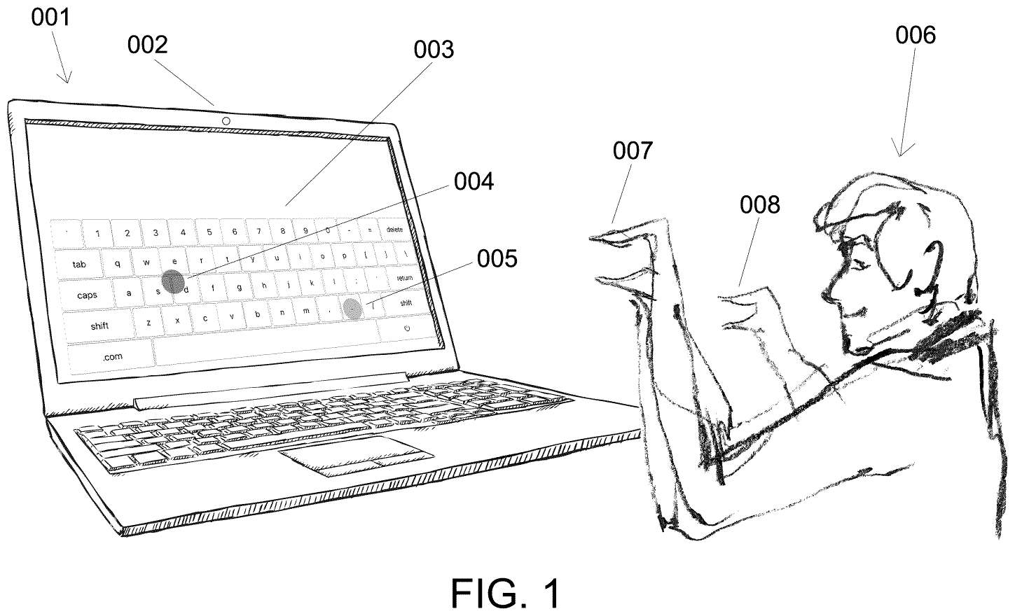

FIG. 2 illustrates the user 006 having kept their hands 007 and 008 in the same spatial positions, however, having brought their right hand 008 to a pinched gesture. What was a smaller, solid circle in FIG. 1 has become a larger, concentrically layered circle 005 over the period key on the graphically displayed keyboard 003 corresponding with the user's right hand 008 so as to indicate the pinched gesture of that hand. A period is input into the computing device 001. The user's left hand 007 remains unpinched so the smaller, solid circle 004 remains accurate in indicating its gesture.

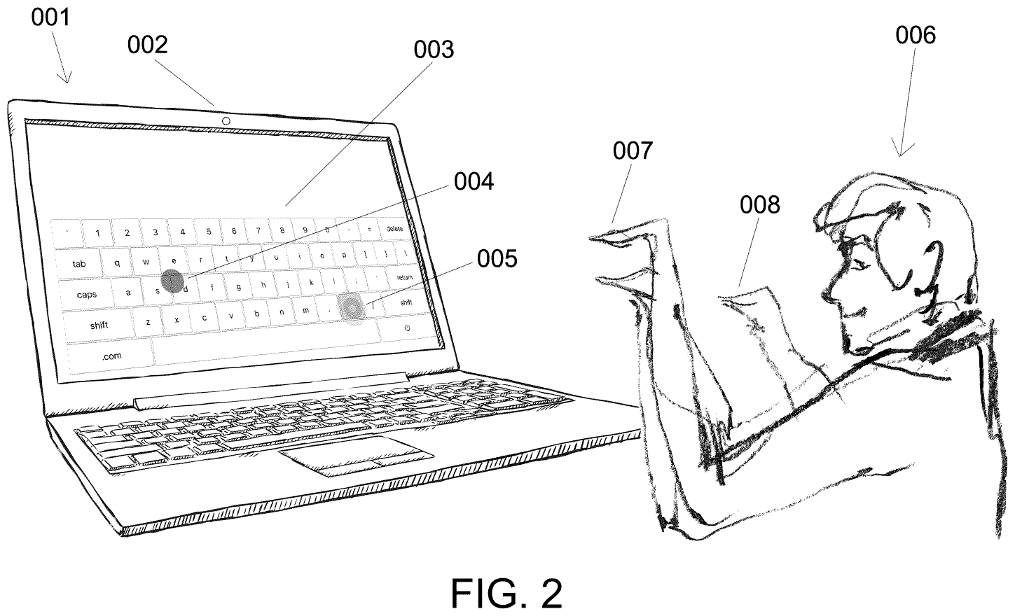

### DETAILED DESCRIPTION AND BEST MODE OF IMPLEMENTATION

The technology disclosed allows a user to input text into a computing device with their hands using a graphically displayed, 3D displayed (including but not limited to those being stereoscopic, multiscopic, holographic or immersive media), or projected keyboard without physically touching the device nor any physical hardware component and without having to wear a separate device on their hand or hands in order to do so. The technology functions by using the computing device's built-in webcam (web camera), external webcam (auxiliary web camera) or other image capturing hardware, including but not limited to radar or radar assisted detection, infrared or infrared assisted detection, or any combination of these technologies, to track the positions and gestures of the user's hands for the purpose of interpreting interactions with the displayed or projected keyboard.

The technology is extensible and agnostic to the nature of the image capturing hardware, which could be but is not limited to any video camera, radar detecting sensor, infrared detecting sensor, various combinations of these, or other. Images from the image capturing hardware are processed in rapid succession by a series of stored procedures interpreting the presence, spatial positions and gestures of the user's hands and their comprising indices. The associated measurements are tracked as percentages of the dimensions of the image capturing hardware's visual field.

The visual field of the image capturing hardware is dynamically rendered to match the measurements of the screen, projection or 3D rendering of the displayed keyboard. The displayed or projected keyboard is agnostic to its hosting medium, which could be any of a range of various screens, 3D displays, including but not limited to stereoscopic, multiscopic, holographic or immersive media displays, or projections, and dynamically responsive such that upon being displayed provides its measurements to a series of stored procedures, which accurately convert them to relative percentages of the hosting medium's measurements.

It is therefore that comparative analyses between the values calculated for the displayed or projected keyboard and those calculated for the user's hands can be used to accurately depict user interaction with the computing device without the requirement of the user physically touching the computing device nor its associated hardware. Significant gestures can be deliberately performed by the user to indicate interaction with the displayed or projected keyboard for the purpose of text input.

The user is free to be at a distance from the computing device while nonetheless inputting text into said device for purposes including but not limited to typing and word processing, sending electronic correspondence such as but not limited to email or other messaging, transmitting data over the internet, entering a query into or interacting with a software application, controlling a game console or Smart TV, also known as a connected TV (CTV), searching or navigating a local or remote file system or file directory, retrieving a file, launching or opening a file in a designated application, or composing artwork.

1. A technology allowing a user to input text into a computing device with their hands and a virtual keyboard without physically touching the computing device nor any physical hardware component and without having to wear a separate device on their hand or hands in order to do so.

2. The technology of claim 1, wherein the virtual keyboard is displayed on a screen.

3. The technology of claim 1, wherein the virtual keyboard is projected from a piece of hardware onto a separate medium.

4. The technology of claim 1, wherein the virtual keyboard is presented as a 3D rending, including but not limited to a stereoscopic, multiscopic, holographic or immersive media display.

5. A technology allowing a user to transmit data over the internet from a computing device using their hands and a virtual keyboard without physically touching the computing device nor any physical hardware component and without having to wear a separate device on their hand or hands in order to do so.

6. The technology of claim 5, wherein the virtual keyboard is displayed on a screen.

7. The technology of claim 5, wherein the virtual keyboard is projected from a piece of hardware onto a separate medium.

8. The technology of claim 5, wherein the virtual keyboard is presented as a 3D rending, including but not limited to a stereoscopic, multiscopic, holographic or immersive media display.

9. A technology allowing a user to interact with a software application hosted locally or on a remote computing device, or cloud hosted application, using their hands and a virtual keyboard without physically touching the computing device nor any physical hardware component and without having to wear a separate device on their hand or hands in order to do so.

10. The technology of claim 9, wherein the virtual keyboard is displayed on a screen.

11. The technology of claim 9, wherein the virtual keyboard is projected from a piece of hardware onto a separate medium.

12. The technology of claim 9, wherein the virtual keyboard is presented as a 3D rending, including but not limited to a stereoscopic, multiscopic, holographic or immersive media display.
